(19) United States
(12) Patent Application Publication
(10) Pub. No.: US 2008/0122928 A1
(43) Pub. Date: May 29, 2008

(54) Stealth mounting system for video and sound surveillance equipment

(75) Inventors: Joel Hutton, Lewisville, TX (US); Matthew Seppeler, Lewisville, TX (US); Dan Hilz, Lewisville, TX (US)

Correspondence Address: STRASBURGER & PRICE, LLP, 901 MAIN STREET, SUITE 4400, DALLAS, TX, 75202, US

(73) Assignee: INX Inc.

(21) Appl. No.: 11/732,032

(22) Filed: Apr. 2, 2007

Related U.S. Application Data
(63) Continuation of application No. 11/595,447, filed on Nov. 9, 2006, now abandoned.
(60) Provisional application No. 60/735,105, filed on Nov. 9, 2005.

(51) Int. Cl. H04N 7/18

(52) U.S. Cl. 348/143; 348/E07.085

(57) ABSTRACT

A stealth-mounting system for video and sound surveillance equipment includes a stealth enclosure. Included within the stealth enclosure is a modularized camera assembly including a camera capable of being remotely positioned and/or a modularized microphone assembly including a microphone capable of being remotely positioned. Surveillance information obtained is provided to another location for storage, monitoring, response or analysis.

### CROSS REFERENCE TO RELATED APPLICATION

This application claims the benefit of Provisional U.S. Patent Application No. 60/735,105 filed Nov. 9, 2005 and is a continuation of U.S. patent application Ser. No. 11/595,447 filed Nov. 9, 2006 now abandoned.

### STATEMENT REGARDING FEDERALLY FUNDED RESEARCH AND DEVELOPMENT

The invention described in this patent application was not the subject of federally sponsored research or development.

### FIELD

The present invention pertains to stealth video and sound surveillance systems; more particularly, the present invention pertains to a system for the mounting and use of stealth video and sound surveillance equipment.

### BACKGROUND

Day and night remote surveillance of key locations to assure secure storage of valuable equipment or to monitor activity levels has become an indispensable tool for those involved in the observation of places or equipment for security purposes. Specifically, the need for protection of valuable equipment or the observation of key locations for terrorist activity, criminal activity (e.g., drug trafficking), espionage, destruction of property, unauthorized border crossing by illegal aliens, or simple theft has grown exponentially in recent years. One reason is the increase in terrorist activity. Another reason is the increase in the value of certain items such as copper. Specifically, the increase in the price of copper has caused an increase in the theft of wire used to transmit electric power—such thefts occurring even when copper electrical power lines are in use. In other more passive applications, pipelines and large metal structures or equipment positioned at remote locations are monitored for signs of damage, wear, fatigue, or corrosion.

Early video surveillance systems, often referred to as closed-circuit TV systems, placed a TV camera in an area of interest and then conveyed the signals obtained from the TV camera either by wire or by a wireless connection to a monitor. At the monitor, the images obtained by one or more TV cameras could be watched by security personnel. Such closed-circuit TV systems are now found in most large buildings, with multiple monitors located at one or more security desks. By use of such closed-circuit TV systems, security personnel monitor the building entrances and egresses, the loading dock, the parking garage, the elevators, the communication equipment, the HVAC equipment and other important areas of the building, simultaneously.

As communication technology has improved in recent years, both clear video images and low volume sounds can be transmitted for monitoring by personnel at remote locations over the Internet, with or without encryption. Accordingly, video images and sounds gathered at one location can be transmitted long distances to a central monitoring center where the images gathered by many different cameras and the sounds picked up by microphones can be monitored. Alternatively, anyone with the proper credentials to gain access to a directed transmission over the Internet can observe what surveillance cameras are recording irrespective of its location in the world. For example, activity at a motor pool in Iraq can be observed at a mobile command post in Europe, a secure location in the Pentagon, or on board an in-flight command and control aircraft—anytime day or night.

To further aid security personnel, the monitoring of the images obtained by surveillance cameras and sounds obtained from sensitive microphones can be made more effective by the use of sophisticated software. Specifically, if the images obtained by a camera indicate movement in a key location, the software can direct the camera to the location where movement is detected then zoom in on the area where movement has been detected. Alternatively, sound can be tracked and the source of the sound can be used to direct the aim of the camera lens. In addition, when movement or sound is detected, an alarm can be transmitted to both response personnel and a command and control center at a remote location. Alternatively, an alarm can be sounded at the location under surveillance or the area can be flooded with light. The video images of the detected movement can then be transmitted to another location for close review by other security personnel, and/or the images obtained can be recorded and stored for use at a later time to assist in investigation of the activity or prosecution of the perpetrators.

While the foregoing advancements in video and sound surveillance have greatly improved security at many locations and reduced the exposure of security to dangerous situations, the most vulnerable portion of a video surveillance system is the camera. The reason for this vulnerability is that the camera and its mounting system are exposed to a wide range of temperatures and climate conditions when mounted outside. Further, the camera is exposed to dust and corrosion factors—which dust and corrosion factors often necessitate periodic replacement of the camera. Further, if the presence of a camera is detected, the camera may be exposed to the risk of damage by those seeking to conduct improper activities in the areas placed under surveillance by the camera.

Accordingly, there is a need in the art for a system usable in a video and sound surveillance environment which will provide a stealth enclosure for video and sound surveillance equipment, which stealth enclosure will enable rapid and simple replacement of the surveillance equipment and associated movement systems, and will further allow operation of the surveillance equipment in a wide range of temperatures and environmental conditions without the need for providing an externally controlled environmental protection system for the camera or sound recording equipment.

### SUMMARY

The system of the present invention provides a stealth enclosure for video and audio surveillance equipment, rapid and simple replacement of the surveillance equipment and associated movement systems, and operation of the surveillance equipment without an externally controlled environmental protection system.

### BRIEF DESCRIPTION OF THE DRAWING FIGURES

A still better understanding of the stealth mounting system for video and sound surveillance equipment of the present invention may be had by reference to the drawing Figures wherein:

FIG. 1 is a schematic of a monitoring system including the present invention;

FIG. 2 is a perspective view of an exemplary surveillance camera system;

FIG. 3 is an exploded perspective view of the exemplary surveillance camera system shown in FIG. 2;

FIG. 4 is a perspective view of an enclosure for the surveillance system shown in FIG. 2 and FIG. 3.

### DESCRIPTION OF THE EMBODIMENTS

Well known in the art are surveillance cameras and surveillance microphones which gather images and sounds and put these images and sounds into a format which can be transmitted over a public or private data network using a variety of communication protocols to include the Internet. Also known in the art are mounting systems for cameras and microphones which can operate the cameras and microphones in response to external signals to obtain a clearer image or enhanced sound to provide a better analysis of activity in a selected area. The cameras, the microphones and the mounting systems therefor make up a camera assembly and a microphone assembly.

The lens for the surveillance camera used in the disclosed system located at the bottom of an enclosure which both masks the presence of the camera and protects the camera and its movement mechanism. The enclosure is shaped and painted to look like something ordinarily seen in an elevated location, such as a transformer or a switch box. Above the camera lens is the body of camera and the mechanism which controls the movement of the lens. Also above the camera lens is the electronics package which converts the image obtained through the lens of the camera into an electrical signal which can be transmitted over a variety of means, such as the Internet. Alternatively, the camera assembly and the electronic package may be modularized for mounting at two or more different locations. Alternatively, multiple cameras may be used—all of which are connected to a single electronics package or to multiple electronics packages when back-up electronic packages may be required.

The microphones used for surveillance in the disclosed system may be arrayed to pick up sounds from a suspect location and to avoid background noise. Alternatively, the microphones may be mounted to be movable to point the microphone in a direction from which sounds originate. Those of ordinary skill in the art will understand that one microphone or multiple microphones may be used. Further, those of ordinary skill in the art will understand the microphones and supporting electrical componentry may be mounted together with the camera or in a separate module.

In a preferred embodiment of the disclosed invention, the camera encapsulates video or still images into an IP packet. The IP packet is then sent to a server. The software in the server allows the user to control the camera for pan, tilt, zoom, iris, opening and focus functions. The stream of images from the camera can be collected in a proprietary, encrypted database, which can be distributed to multiple locations, or stored on a local or remote hard drive or network drive for archive purposes.

Camera assemblies with or without microphone assemblies can be used for surveillance by being mounted to a utility pole or to the side of a building. Multiple video and/or audio feeds obtained from a plurality of cameras/microphones can be directed by secure wire or by a secure wireless connection to a central host site or a remote location or to both simultaneously. The operation of the camera and/or microphone can be controlled from the remote location. Alternatively, the remote location receiving the video/audio feeds may even be a vehicle with the appropriate wireless capabilities to receive a signal representing the video images or sounds obtained by the camera/microphones.

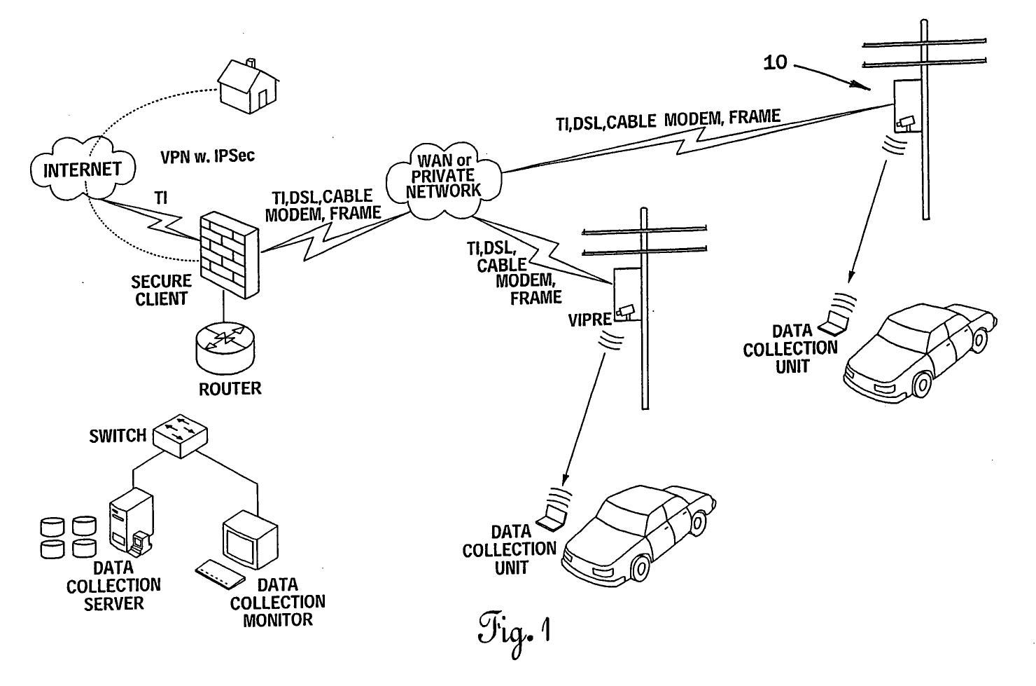

Shown in FIG. 1 is a wide area network application in which a camera and/or sound collection devices 10 mounted on a utility pole obtain a signal indicating some sort of criminal activity; for example, one or more robberies. The video signal is then sent via a wide area network to a secure client location. The signal received at the secure client location may then be transmitted to a designated alarm location to alert law enforcement or response personnel.

Video or sound surveillance information may be transmitted by a series of switches and/or routers to a recording system for collecting and storing the video and sound data obtained for future use by forensic crime scene investigation teams and/or to another location where the ongoing criminal activity may be monitored. Further, the video and sound data may also be transmitted to a vehicle that may be patrolling in the area of the criminal activity or sent in response to an alarm. Alternatively, the video and sound data recorded by the camera could be archived within the camera assembly or microphone assembly and then manually or electronically transported to a command center for storage at a separate data collection facility. For use at a later time or comparison to other video our sound data for analysis.

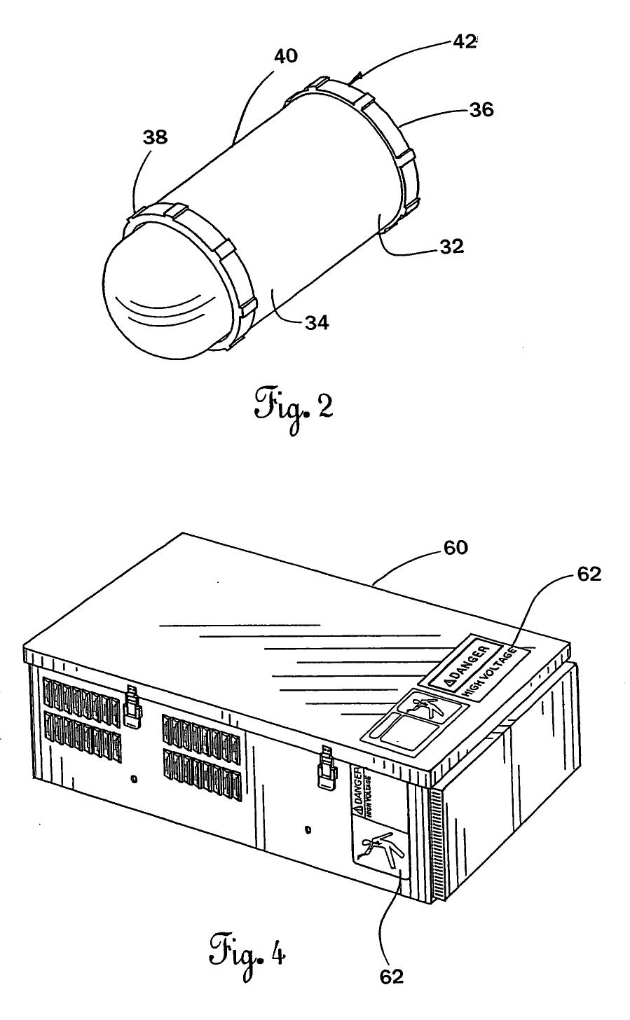

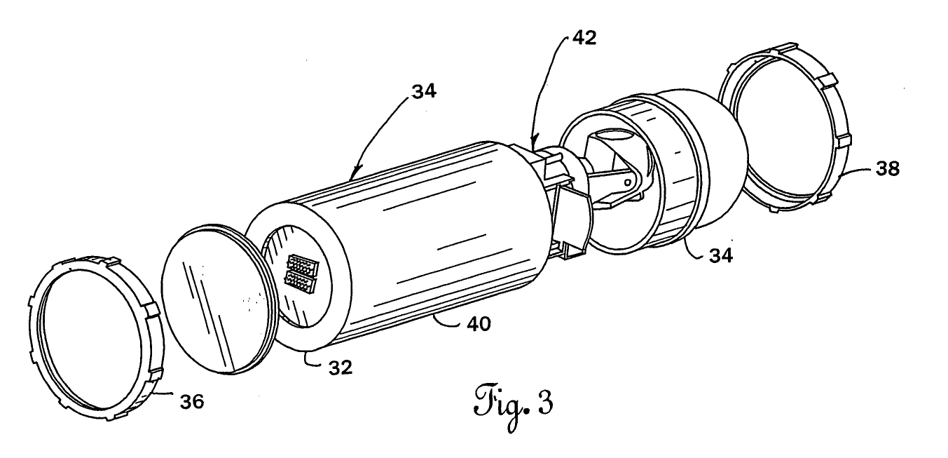

Shown in FIG. 2 and in FIG. 3 is an exemplary covert camera assembly 42. At the top 32 and the bottom 34 are large mounting rings 36, 38 which can easily be unscrewed from a camera system enclosure 40 to remove and replace the camera assembly 42, as needed. No special tools are required. Because of the size and the minimum numbers of parts, a worker will be easily able to remove an inoperative camera and replace it with an operative camera, even in cold environments where gloves are typically worn. All components are sized and constructed so that they can only be put together in one way.

For other types of cameras and movement control mechanisms, particularly those used in extreme climates, the camera and movement mechanism is contained in a sealed insulating environment, such as in nitrogen gas, so that extreme temperatures will not distort the images produced by the camera. When the camera and the movement mechanism are in a sealed insulating environment, the entire camera and movement mechanism are replaceable as a unit.

Shown in FIG. 4 is one example of an exterior stealth enclosure 60 for the mounting for the camera assembly 42. Where NEMA electrical equipment standards are required, the enclosure may be constructed to comply with all such standards. The portions marked “DANGER HIGH VOLTAGE” are actually perforated vinyl or metal screens 62 which allow the camera mounted within the enclosure to gather images. Alternatively, the surveillance equipment may be mounted in a large, round cylindrical enclosure including small view screens. The large, round cylinder is constructed to give the same appearance to the observer as an electrical transformer or a large capacitor.

The stealth enclosure 60 includes mounting brackets which permit the mounting for the camera assembly 30 and/or the microphone assembly to be installed in the exterior enclosure in only one way. Because of the way the electrical connections are sized and positioned in the disclosed system 10, there is only one way for the mounting for the camera assembly 30 to be placed in the exterior stealth enclosure. The number of fasteners used to secure the mounting for the camera assembly to be placed in the exterior stealth enclosure 60 is minimized. Quarter-turn fasteners or wing-nut fasteners are used so that no special tools are required when exchanging an inoperative camera assembly for an operative camera assembly 30.

Those of ordinary skill in the art will understand that, while a switch box is shown as the external stealth enclosure 60, a variety of different stealth enclosures having various sizes, shapes, and surface finishes which either are normally found or easily blend into an environment, may be used without departing from the scope of the invention. The key feature of the exterior stealth enclosure 60 is that it is large enough to both permit a wide range of visibility for the camera lens or sound surveillance equipment and allow sufficient air flow around the camera assembly 30 so that the camera, its mounting systems, and the associated electronics package may operate in a wide range of temperatures without any auxiliary cooling.

All materials selected for use in the present invention are operable in a wide range of operating temperatures ranging from about −40° Celsius to about +60° Celsius. Accordingly, the present invention is usable in most locations worldwide.

While the present invention has been described in terms of the foregoing embodiment, those of ordinary skill in the art will understand that multiple embodiments of the invention have been enabled by an understanding of the foregoing embodiment. Such embodiments shall be included within the scope and meaning of the appended claims.

What is claimed is:

1. A video surveillance information-gathering system, said system comprising:
a camera assembly, said camera assembly including:
a camera for gathering video images;
means for moving said camera;
means for transmitting said video images to a reception point;
a mounting system for said camera assembly, said mounting system constructed and arranged to:
permit the mounting of said camera assembly only in an operational position;
permit the removal and replacement of said camera assembly without tools;
provide the necessary connections for control of the position and operation of said camera and receipt and transmission of images obtained from said camera;
surround said camera assembly in a stealth enclosure, said stealth enclosure constructed and arranged to provide sufficient airflow around said camera assembly to allow said camera assembly to operate without auxiliary cooling.

2. An audio surveillance information-gathering system, said system comprising:
a microphone assembly, said microphone assembly including:
at least one microphone for gathering sounds;
means for moving said at least one microphone;
means for transmitting said sound to a reception point;
a mounting system for said microphone assembly, said mounting system constructed and arranged to:
permit the mounting of said microphone assembly only in an operational position;
permit the removal and replacement of said microphone assembly without tools;
provide the necessary connections for control of the position and operation of said at least one microphone and receipt and transmission of the sound obtained from said at least one microphone;
surround said microphone assembly in a stealth enclosure, said stealth enclosure constructed and arranged to provide sufficient airflow around said microphone assembly to allow said microphone assembly to operate without auxiliary cooling.

3. A video and audio surveillance information-gathering system, said system comprising:
a camera assembly, said camera assembly including:
at least one camera for gathering video images;
means for moving said camera;
means for transmitting said video images to a reception point;
a microphone assembly, said microphone assembly including:
a microphone for gather sounds
means for moving said microphone;
means for transmitting said sound to a reception point;
a mounting system for said camera assembly and said microphone assembly, said mount system constructed and arranged to:
permit the mounting of said camera assembly and said microphone assembly only in an operational position;
permit the removal and replacement of said camera assembly and said microphone assembly without tools;
provide the necessary connections for the control of the position and operation of said camera and said microphone and transmission of the surveillance information obtained from said camera and said microphone;
surround said camera assembly and said microphone assembly in a stealth enclosure, said stealth enclosure constructed and arranged to provide sufficient airflow around said camera assembly and said microphone assembly to allow said camera assembly to operate without auxiliary cooling.

4. The system as defined in claim 1 wherein said camera assembly will provide usable surveillance information in operating temperatures from about −40° C. to about +60° C.

5. The system as defined in claim 2 wherein said microphone assembly will provide usable surveillance information in operating temperatures from about −40° C. to about +60° C.

6. The system as defined in claim 1 wherein said camera assembly is enclosed within a self-contained module.

7. The system as defined in claim 2 wherein said microphone assembly is enclosed within a self-contained module.

8. The system as defined in claim 1 wherein said stealth enclosure has a shape and surface finish to disguise it as another object.

9. The system as defined in claim 2 wherein said stealth enclosure has a shape and surface finish to disguise it as another object.

10. The system as defined in claim 1 wherein said stealth enclosure has a shape and surface finish to blend in with its surrounding environment.

11. The system as defined in claim 2 wherein said stealth enclosure has a shape an surface finish to blend in with its surrounding environment.

12. The system as defined in claim 1 further including a system for transmitting said video images to a remote location.

13. The system as defined in claim 1 further including a system for transmitting said sound to a remote location.

14. The system as defined in claim 1 wherein the position of said camera is controlled from a remote location.

15. The system as defined in claim 2 wherein the position of said at least one microphone is controlled remotely.

16. The system as defined in claim 3 wherein the surveillance information obtained is stored at a remote location.

17. The system as defined in claim 3 wherein the surveillance information obtained is monitored.

18. The system as defined in claim 3 wherein the surveillance information obtained triggers action by a response team.

19. The system as defined in claim 3 wherein the surveillance information obtained is used for compensation with other surveillance information.
